(19) United States
(12) Patent Application Publication
(10) Pub. No.: US 2025/0281931 A1
(43) Pub. Date: Sep. 11, 2025

(54) High-Throughput Expansion Microscopy, Devices for Use With a Well Plate and Methods for Processing a Sample

(71) Applicant: MASSACHUSETTS INSTITUTE OF TECHNOLOGY, Cambridge, MA (US)

(72) Inventors: Laurie A. BOYER, Cambridge, MA (US); Alexander L. AULD, Boston, MA (US); Edward S. BOYDEN, Chestnut Hill, MA (US); John H. DAY, Cambridge, MA (US); Pema MARETICH, Cambridge, MA (US); Catherine Della SANTINA, Cambridge, MA (US)

(73) Assignee: MASSACHUSETTS INSTITUTE OF TECHNOLOGY, Cambridge, MA (US)

(21) Appl. No.: 18/858,844

(22) PCT Filed: Apr. 17, 2023
(86) PCT No.: PCT/US2023/018814

§ 371 Date: Oct. 22, 2024

Related U.S. Application Data
(60) Provisional application No. 63/335,749, filed on Apr. 28, 2022.
(60) Provisional application No. 63/479,646, filed on Jan. 12, 2023.

(51) Int. Cl. B01L 3/00

(52) U.S. Cl. CPC B01L 3/52; B01L 2200/025; B01L 2200/0642; B01L 2300/0829; B01L 2400/0406

(57) ABSTRACT

Aspects of the present disclosure are directed to a device configured to be inserted into a well plate. The device may include a main body having a top side and a bottom side, and a plurality of posts extending downwardly from the bottom side of the main body, where the plurality of posts is sized to be inserted into a well plate. The device may further include a plurality of post passageways extending through the plurality of posts. The plurality of posts each have a terminus end opposite the main body, where the terminus ends of the plurality of posts further include a plurality of tapered tips. The present disclosure is also directed to methods of processing a plurality of samples in a well plate using the above-described device.

### RELATED APPLICATIONS

This application claims the benefit under 35 U.S.C. § 119(e) of U.S. Provisional application Ser. No. 63/335,749 filed Apr. 28, 2022, and also U.S. Provisional application Ser. No. 63/479,646 filed Jan. 12, 2023, both disclosures of which are incorporated by reference herein in their entirety.

### FIELD OF DISCLOSURE

Aspects of the present disclosure are directed to a device for use with a well plate and also to a platform that enables scalable expansion microscopy and super-resolution imaging.

### BACKGROUND

Expansion microscopy (ExM) involves the physical, isotropic expansion of biological samples that allows for nanoscale resolution imaging using a diffraction limited microscope. ExM has been widely employed to image proteins, nucleic acids, and lipid membranes in single cells.

### SUMMARY OF DISCLOSURE

According to one aspect, a device configured to be inserted into a well plate is provided. The device includes a main body having a top side and a bottom side, and a plurality of posts extending downwardly from the bottom side of the main body, where the plurality of posts is sized to be inserted into a well plate. The device may also include a plurality of post passageways extending through the plurality of posts, where the plurality of posts each have a terminus end opposite the main body, and where the terminus ends of the plurality of posts include a plurality of tapered tips.

According to another aspect, a method of processing a plurality of samples in a well plate is provided. The method may include providing a well plate, the well plate having a plurality of wells, depositing a plurality of samples in the plurality of wells, and providing a first device configured to be inserted into the well plate. The first device may include a plurality of posts sized to be inserted into the plurality of wells; where the plurality of posts has a plurality of post passageways extending therethrough, and where the plurality of posts each have a terminus end, where the terminus ends of the plurality of posts include a plurality of tapered tips. The method may also include depositing a first solution onto the plurality of tapered tips of the first device, and inserting the first device into the well plate such that the plurality of posts is inserted into the plurality of wells of the well plate to mix the first solution with the plurality of samples in the plurality of wells.

### BRIEF DESCRIPTION OF THE DRAWINGS

FIG. 1A is a perspective top view of one embodiment of a device according to the present disclosure shown in a position adjacent a well plate;

FIG. 1B is a perspective bottom view of the device shown in FIG. 1A;

FIG. 1C is a top view of the device shown in FIG. 1A;

FIG. 1D is a side view of the device shown in FIG. 1A;

FIG. 1E is an end view of the device shown in FIG. 1A;

FIG. 1F is a detailed view of a conical post tip shown in FIG. 1D;

FIG. 2 illustrates one embodiment of a generalized protocol for using a device such as the one shown in FIGS. 1A-1F with a first solution and a second solution;

FIG. 3 illustrates mouse embryonic fibroblasts (MEFs) immunostained with anti-alpha tubulin antibody in a 96 well plate shown pre-expansion at 40× (left) and post-expansion at 20× (right) resulting from using the device and imaged on a Nikon A1R confocal microscope;

FIG. 4 illustrates overlay of pre-expansion and post-expansion MEFs with line scan;

FIG. 5 illustrates the ability of the high-throughput Expansion Microscopy (hiExM) device and protocol to improve the resolution of individual microtubules compared to pre-expansion images;

FIG. 6 illustrates that high-throughput Expansion Microscopy (hiExM) yields improved resolution of human induced pluripotent stem cell derived cardiomyocytes (hiPSC-CM) sarcomeres after expansion process;

FIGS. 7A-7B illustrate a line scan analysis of sarcomeres demonstrating resolution of sarcomere components in hiPSC-CMs before and after hiExM application;

FIG. 8A illustrates representative immunofluorescence images of A549 Human lung adenocarcinoma cells immunostained with anti-alpha tubulin antibodies in a 96-well plate (left), a single well (middle) and at the single cell level (right) using hiExM;

FIG. 8B illustrates mean root mean square (RMS) measurement length error for 43 wells using hiExM devices across three independent wells;

FIG. 8C illustrates a comparison of expansion factor as measured by linear distance between microtubules in the same cell pre- and post-hiExM based on immunostaining using anti-alpha tubulin across 3 independent plates;

FIG. 9 illustrates one embodiment of a generalized protocol for using a device such as the one shown in FIGS. 1A-1F with a first solution;

FIG. 10A is a top view of one embodiment of a hiExM device according to the present disclosure;

FIG. 10B is a bottom view of the device shown in FIG. 10A;

FIG. 10C is a side view of the device shown in FIG. 10A;

FIG. 10D is an end view of the device shown in FIG. 10A;

FIG. 10E is a detailed view of a portion of the device shown in FIG. 10A;

FIG. 10F is a cross-sectional view of the device shown in FIG. 10B;

FIG. 10G is a detailed view of a portion of the device shown in FIG. 10D;

FIG. 11A is a perspective view of one embodiment of a portion of a device according to the present disclosure which includes a post;

FIG. 11B is a top view of the embodiment shown in FIG. 11A;

FIG. 11C is a side view of the embodiment shown in FIG. 11A;

FIG. 11D is another side view of the embodiment shown in FIG. 11A;

FIG. 11E is another perspective view of the embodiment shown in FIG. 11A;

FIG. 11F is a bottom view of the embodiment shown in FIG. 11A;

FIG. 11G is a detailed bottom view of the embodiment shown in FIG. 11F; and

FIG. 12 illustrates other embodiments of the present disclosure.

### DETAILED DESCRIPTION

As described below, aspects of the present disclosure are directed to a device which is configured to be inserted into a well plate. The device may be used to process a plurality of samples in the well plate. In one embodiment, imaging of the samples in the well plate may be performed. The device may be part of a platform which employs expansion microscopy. Expansion microscopy (ExM) is discussed above. Applicant recognized that the current methods that employ Expansion microscopy (ExM) are low throughput. As set forth in more detail below, aspects of the present disclosure are directed to the design and validation of High-throughput Expansion Microscopy (hiExM), a robust and inexpensive platform that allows parallel processing and automated imaging of diverse cell types within multi-well cell culture plates. In one embodiment, this platform is fully adaptable to high-content image analysis enabling a range of applications including high-resolution drug discovery and screening as well as nanoscale resolution of cellular changes associated with pathological states in human primary cells. As set forth in more detail below, in one embodiment, this disclosure represents a new tool for academic labs as well as the pharmaceutical and biotechnology industries where high-resolution imaging of many samples across a range of comparative conditions can greatly facilitate biological discovery and translational applications.

The Applicant recognized that the ability to resolve subcellular features is critical for biological discovery, identification of disease targets, and the development of therapeutics. Super resolution microscopy methods (e.g., SIM, EM, STORM and PALM) enable nanoscale imaging of specimens, however, these approaches require specialized reagents, costly microscopes, and extensive microscopy expertise. Expansion microscopy (ExM) is an alternative, inexpensive and accessible method that similarly resolves subcellular structures by isometrically enlarging specimens that can be imaged with a conventional fluorescence microscope. However, current techniques employing both super-resolution and ExM are limited in throughput, allowing processing and imaging of few samples at a time making these approaches inaccessible for high-throughput applications. To broaden the tremendous utility of ExM, the Applicant designed and validated a robust platform, which in one particular embodiment, is called High-throughput Expansion Microscopy (hiExM), and enables parallel sample processing in a single well or in one of a plurality of wells in a container comprising one or more wells. A non-limiting example of a container suitable for use in methods of the invention is a 96-well cell culture plate (i.e., a 96-well plate) that is fully adaptable to high-content image analysis. It should be apparent that in another embodiment, the platform may be used with other sized wells and well plates (including, but not limited to single well, 2, 3, 4, 5, 6, 7, 8, 9, 10, 11, 12-well, 24-well, 48-well, 384-well, or a greater number of wells, including a well plate with any number of wells between the aforementioned integers) as the disclosure is not so limited.

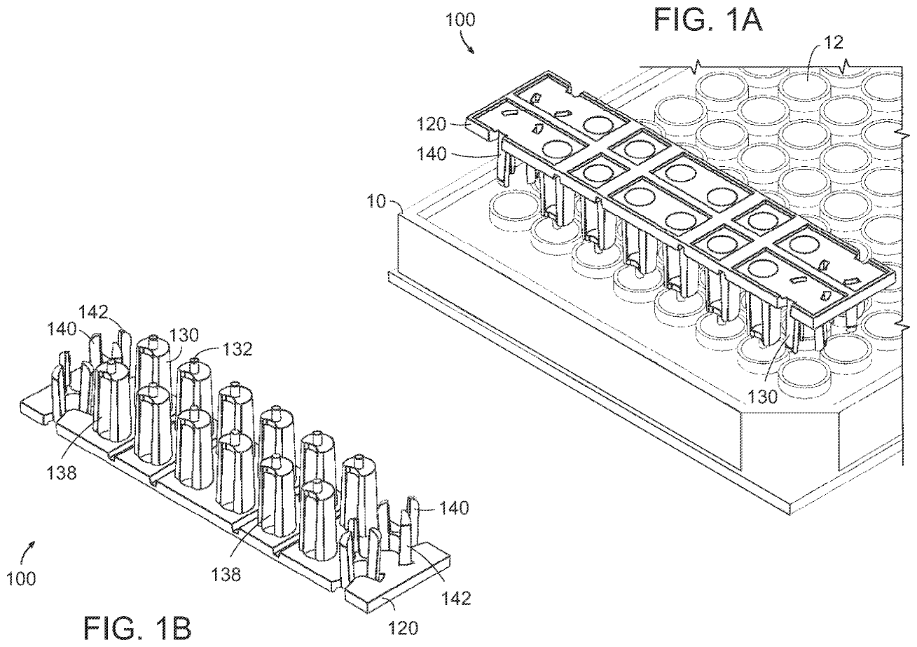

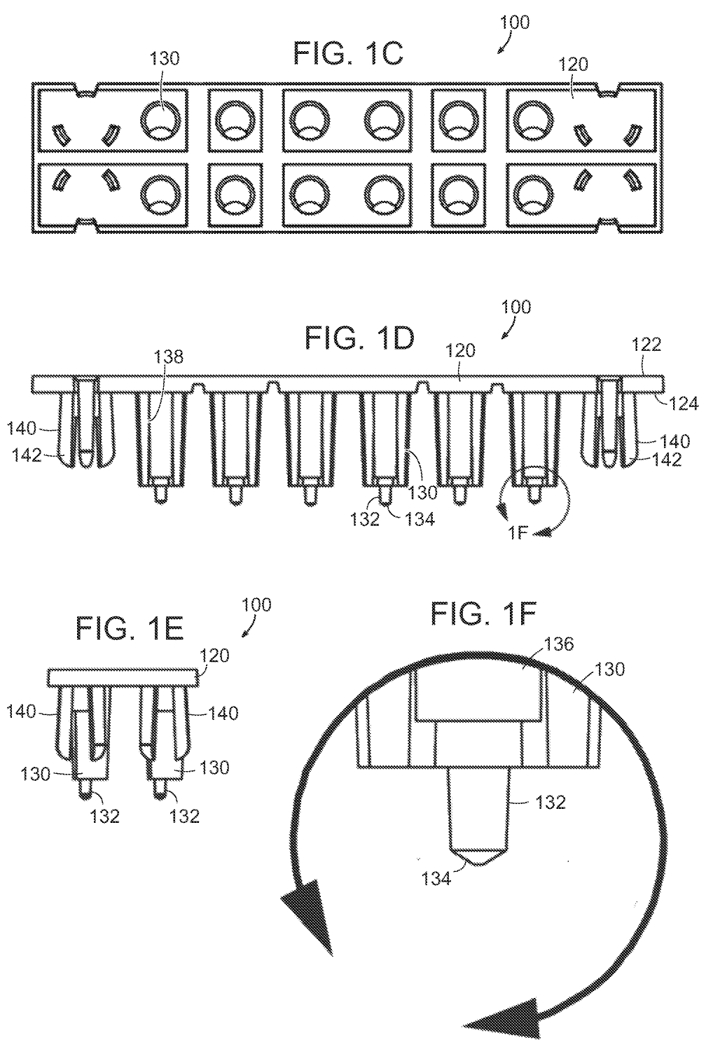

As shown in FIG. 1A-1F, aspects of the present disclosure are directed to a device 100 which is configured to be inserted into a well plate 10. The Applicant recognized that it would be desirable to have a platform that can process a plurality of samples simultaneously in a well plate. As set forth below, in one embodiment, this device 100 may be used to perform expansion microscopy on the samples. As described in more detail below, in one embodiment, the device is configured with a plurality of tapered tips 134 which are designed to allow an underlying volume of material to swell unencumbered. This enables the device 100 to be well suited for ExM applications. The device may be easily manufactured, and in one embodiment, the device is injection molded.

As shown in FIG. 1A-1F, in one illustrative embodiment, the device 100 includes a main body 120 having a top side 122 and a bottom side 124. As shown, a plurality of posts 130 extend downwardly from the bottom side 124 of the main body 120 and the plurality of posts 130 are sized to be inserted into the wells 12 of a well plate 10 and may be configured to deliver a small volume of liquid. In one illustrative embodiment, there are a plurality of post passageways 136 extending through the plurality of posts 130. The plurality of posts 130 each have a terminus end 132 opposite the main body 120, and as shown, the terminus ends 132 of the plurality of posts 130 include a plurality of tapered tips 134. As set forth in more detail below, the terminus end 132 of the posts 130 may be used to collect one or more solutions used to process the samples.

As discussed in more detail below, the present disclosure contemplates a variety of different configurations of tapered tips 134, including, but not limited to conical shaped tips, truncated conical shapes, as well as non-conical shapes (both truncated and non-truncated). Applicant recognized that the geometry of a tapered tip 134 with a width that narrows toward its distal end may be desirable as it does not restrict and/or limit the swelling of a volume of a gel solution. More specifically, Applicant recognized that the tapered tip 134 may be desirable to retain a <1 microliter droplet of gel solution and impose no limit on the expansion of the cured gel when the device 100 is placed in a well plate 10.

Furthermore, as outlined in more detail below, the tapered tips 134 may include at least one feature that forms open capillary channels on the outer tapered surface which may be desirable when the device is used to process certain types of samples.

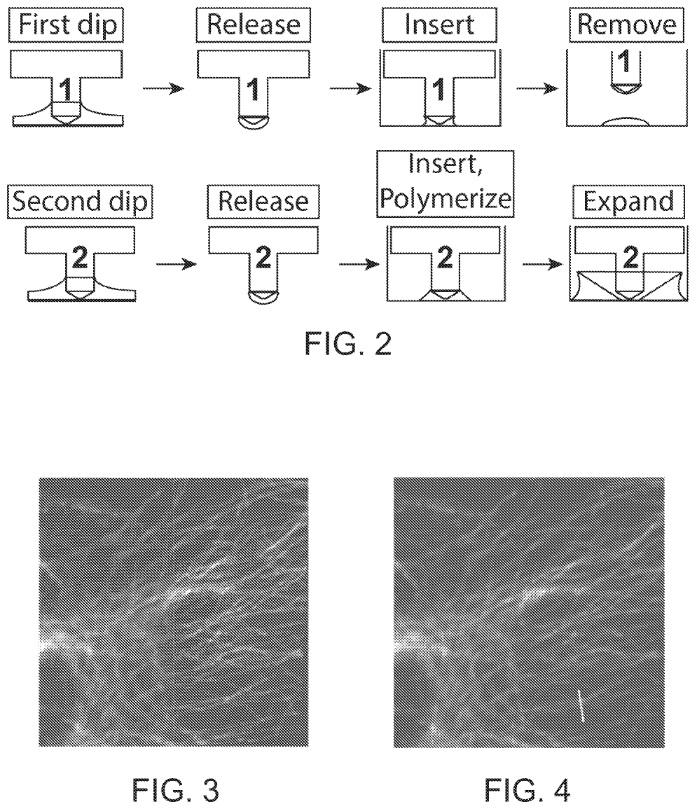

The present disclosure contemplates a device which may be used to process various types of samples in a well plate. In one embodiment, the device may be used to process one solution. For example, as shown in FIG. 9, and as described in more detail below, in one embodiment, a photo-initiator may be used with a one-step protocol that utilizes UV light to initiate a reaction in the solution. In another embodiment, the device may be used with a two-step protocol as shown in FIG. 2.

Turning now to FIG. 2, which illustrates an overview of one embodiment which incorporates multiple devices 100 to process a sample. In this embodiment, a first device 100 may be used to dispense a first solution into the plurality of wells 12 of the well plate 10, and a second identical device 100 may be used to dispense a second solution into the plurality of wells 12 of the well plate 10.

As shown in FIG. 2, first the tips 134 of the posts 130 of a first device 100 may be dipped into a reservoir containing a first solution fluid so that a small volume of the first solution is held on the tip 134. The fluid may be retained by surface tension in a droplet on the surface of the post tip 134. Second, the device 100 may be released or otherwise lifted out of the first solution, and thereafter the device 100 may be inserted into the well plate 10 to dispense the small volume of the first solution into each of the wells 12 of the well plate 10, and then the first device may be removed from the well plate. Thereafter, the tips 134 of the posts 130 of a second device 100 may be dipped into a reservoir containing a second solution fluid so that a small volume of the second solution is held on each tip 134. As mentioned above, the fluid may be retained by surface tension in a droplet on the surface of the post tip 134. The second device may be released or otherwise lifted out of the second solution, and thereafter the second device 100 may be inserted into the same well plate 10 to dispense the small volume of the second solution into each of the wells 12 of the well plate 10. The second device may remain in the well plate. As set forth in more detail below, this is one approach for using the device 100 to dispense multiple solutions into a well plate. As set forth below, in one embodiment, the first and second solutions react to form gels which may be used in expansion microscopy followed by high content imaging. As outlined below, other approaches, including a one solution embodiment shown in FIG. 9, are also contemplated as the disclosure is not so limited.

As illustrated in FIG. 1A-1F, the device 100 may include a plurality of pressure struts 140 extending downwardly from the bottom side 124 of the main body 120. These pressure struts are sized to be inserted into a well plate 10. One of ordinary skill in the art will appreciate that the pressure struts 140 are designed to sustain downward force which may be imposed when the device 100 is initially inserted into the well plate 10. In one embodiment, the device 100 may include a first pressure strut 140 positioned on the left side of the main body, and a second pressure strut 140 positioned on the right side of the main body. In one illustrative embodiment, the pressure struts 140 are configured to align with the outermost wells 12 of the well plate 10. Furthermore, as shown in FIG. 1A, each pressure strut 140 may include a plurality of prongs 142 which extend downwardly from the main body 120. As shown in FIG. 1B, in one particular embodiment, the device 100 includes four pressure struts 140 (one in each corner of the device), and each pressure strut 140 includes three prongs 142.

In the embodiment illustrated in FIG. 1A-1F, the main body 120 is shown as having a substantially rectangular shape and the plurality of posts 130 are shown having a substantially cylindrical shape. In other embodiments, the main body 120 and the plurality of posts 130 may have a different configuration as the disclosure is not so limited. Furthermore, and discussed in more detail below, the tips 134 having other angular configurations are also contemplated. It should also be recognized that the number of posts 130 on the device 100 may vary as the disclosure is not so limited. In one particular illustrative embodiment, the device 100 has 12 posts 130. It should be apparent that in another embodiment, the device 100 may have a different number of posts (including, but not limited to 12, 24, 48, 60, 96, 384 etc.) as the disclosure is not so limited.

Furthermore, various post configurations are contemplated. As shown in FIGS. 1A-1F, in one embodiment, the posts 130 include one or more openings 138 along the post sidewalls. It should be appreciated that these openings 138 may enable a fluid to travel through the post passageway 136 and out through the openings 138. When the device 100 is placed in a well plate 10, this may enable one to dispense a fluid from the top into the post passageway 136 through the device 100 and into a well 12. In another embodiment, the posts 130 may include substantially solid walls (i.e., without openings 138). In one embodiment, the post sidewalls are substantially vertical (i.e., substantially perpendicular to the plane defining the main body 120). Furthermore, in one illustrative embodiment, the openings 138 are configured as cutouts in the material forming the post sidewalls. It should be appreciated that the present disclosure contemplates openings 138 having a different configuration, as the disclosure is not so limited. In one illustrative embodiment, the tapered tips 134 are substantially solid. In another embodiment, it is contemplated that the post passageway 136 extends through or at least partially through the tips 134.

FIGS. 3-8 illustrates various experimental results which are discussed in more detail in the Examples section below.

FIG. 9 illustrates an overview of one embodiment of the present disclosure which illustrates one device 100 to process one solution in a one-step photochemistry protocol. In this particular embodiment, a photo-initiator is used with a one-step protocol that utilizes UV light to initiate a reaction in the solution. As shown in FIG. 9, first the tapered tips 134 of the posts 130 of a first device 100 may be dipped into a reservoir containing a first solution fluid so that a small volume of the first solution is held on the tip 134. The fluid may be retained by surface tension in a droplet on the surface of the post tip tapered 134. Second, the device 100 may be released or otherwise lifted out of the first solution, and thereafter the device 100 may be inserted into the well plate 10 to dispense the small volume of the first solution into each of the wells 12 of the well plate 10. Next, the well plate 10 may be irradiated. As shown, after the irradiation, the solution has expanded to form a gel.

It should be appreciated that these process conditions may vary. In one particular embodiment, photoinitiator Irgacure 2959 is dissolved in dimethyl sulfoxide (DMSO) at ˜500 mg/mL. Then 20 μL of Irgacure in dimethyl sulfoxide (DMSO) may be mixed with 1 mL of gel solution containing sodium chloride (NaCl) in a concentration that was reduced relative to the original protein-retention expansion microscopy gel solution, from 2M down to 1.8M. The primed gel solution may then be brought into a glove bag along with devices 100 and the well plate 10 bearing cells fixed with 4% paraformaldehyde and stained with desired antibodies. Oxygen may be purged from the glove bag and phosphate buffered saline (PBS) may be aspirated from the cells in the well plate 10. At this point, the gel solution may be poured into a reservoir and devices 100 may be dipped into the gel solution to collect at the tips 134 of the device posts 130. The loaded device 100 may then be inserted into the well plate 10, and the process may be repeated until gels are deposited into all wells 12. The well plate 10 may then then irradiated with 365 nm light at approximately 20 to approximately 80 mW/cm² for about 1 minute. After irradiation, the gels are formed and the protocol continues. One of ordinary skill in the art will appreciate that the process conditions may vary, and for example, the immunostaining may occur at different steps.

It should be appreciated that the above technique described above and shown in FIG. 9 substitutes the second set of dipping steps for an irradiation step (described above and shown in FIG. 2) since the mechanism to initiate polymerization involves a photochemical reaction rather than an oxidation-reduction chemical reaction. It should be appreciated that the devices 100 described in the present disclosure may be employed in a variety of different techniques for processing a sample.

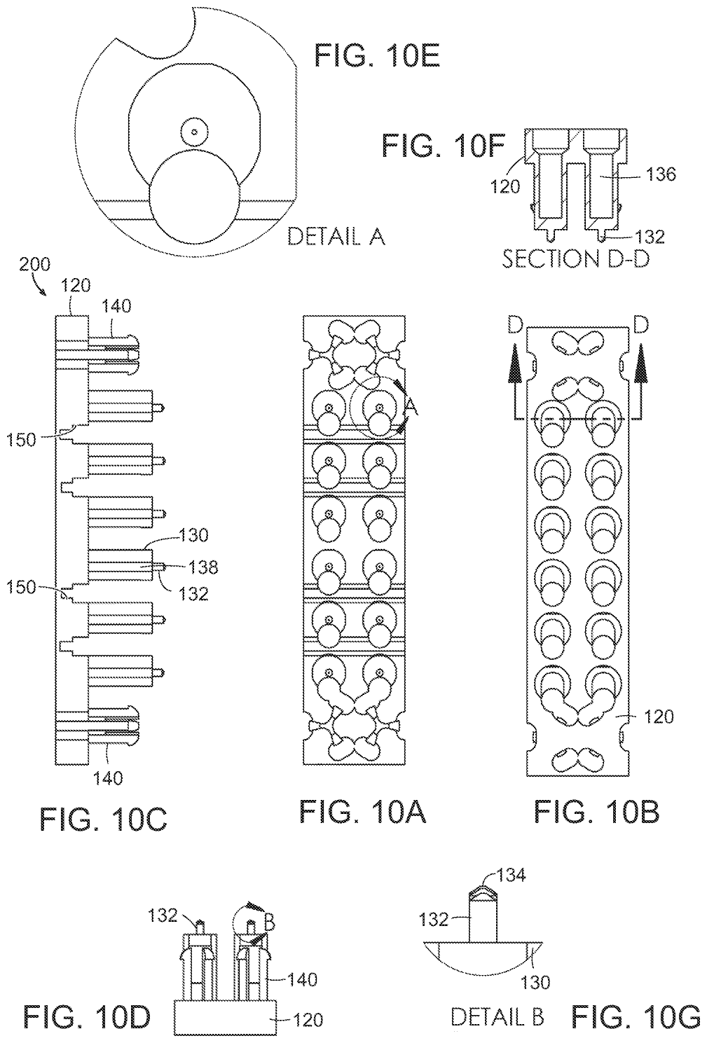

FIGS. 10A-10F illustrates yet another embodiment of a device 200 which is configured to be inserted into a well plate 10. This figure includes many components that have been described above and shown in FIGS. 1A-1F, and thus like components have been given identical reference numbers. Measurements (in mm) and details are shown for this particular device 200. In one non-limiting embodiment, the device 200 is manufactured using polysulfone.

The inside surface of a well 12 may be considered the well culture plate surface. Applicant recognized that since the expansion gels may contact both the cell culture plate surface and the device, ensuring that the posts 130 effectively delaminate from the gel upon removal is a key design feature. Applicant also recognized that it may be important for the device 200 to be compatible with injection molding for high-throughput fabrication. Applicant further recognized that the toroid geometry of the gel combined with the sloped surface of the tapered tips 134 allow the gel to expand while the device is present in the well 12. Also, gel expansion causes the gel to delaminate from the post 130, enabling robust removal of the device without disrupting the gel for imaging.

As shown in FIGS. 10A-10F, in one embodiment, the difference in the post length along the long axis of the device 200 allows the center posts 130 to contact with the cell culture surface first. When the device 200 is pressed down on its short edges, deformation in the spine of the device 200 occurs first close to the center, then propagates toward the edges as each subsequent set of posts meets the culture surface. This sequential deformation ensures that each post makes full contact with the culture surface when downward force is applied on the short edges of the insert.

This difference in post length is shown in the detailed views shown in the embodiment shown in FIGS. 10D and 10G. For example, in one illustrative embodiment, the length of a post 130 positioned in the center of the main body 120 is 2.09 mm, and as one moves to the outermost posts (either towards the left side or the right side of the main body 120), the length of the next post 130 is slightly less at 1.99 mm, and then the length of the adjacent outermost post 130 is slightly less at 1.79 mm. In this configuration, the length of a post 130 positioned in the center of the main body 120 is longer than the length of a post positioned on either the left or right side of the main body.

As shown in FIGS. 10A-10F, the device 200 may include a plurality of notches 150 on the bottom side of the main body. The plurality of notches 150 may permit flexing of the main body as the device 200 is inserted into a well plate 10. As mentioned above, the post lengths may be configured so that the longest posts 130 are in the center of the main body 120. Thus, the device 200 may be configured so that the center posts 130 contact with the culture surface inside of the wells 12 first. As shown, the notches 150 may be positioned on each side of these center posts 130 to facilitate the flexing of the main body towards the right and left side of the main body 120 as the device 200 is inserted into the well plate 10.

As mentioned above, a plurality of post passageways 136 may extend through the plurality of posts 130. As shown in the section of FIG. 10F, in one embodiment, the plurality of post passageways 136 also extends up through to the top side 122 of the main body 120. As shown in FIG. 10F, the diameter of the post passageways 136 may vary through the passageway 136. As shown, at the top side 122 of the main body 120 the diameter may be about 6.35 mm, and in the posts 130, the post passageway 136 may taper down to a diameter of approximately 4 mm. And as shown in FIG. 1F, the terminus end 132 of the posts 130 may include a truncated tapered tip 134 that has a diameter of approximately 1.2 mm that tapers down to about 0.2 mm. Other configurations are also contemplated. In one embodiment, the post passageway diameter ranges from 0.1 mm-7 mm.

As mentioned above, the Applicant contemplates a variety of tapered post tip 134 configurations. As discussed above, the tapered post tip 134 is configured such that a fluid can be retained by the surface tension in a droplet on the surface of the post tip 134. As mentioned above, a conical shaped tip 134 may be desirable so that gel expansion causes the gel to delaminate from the post tip 134.

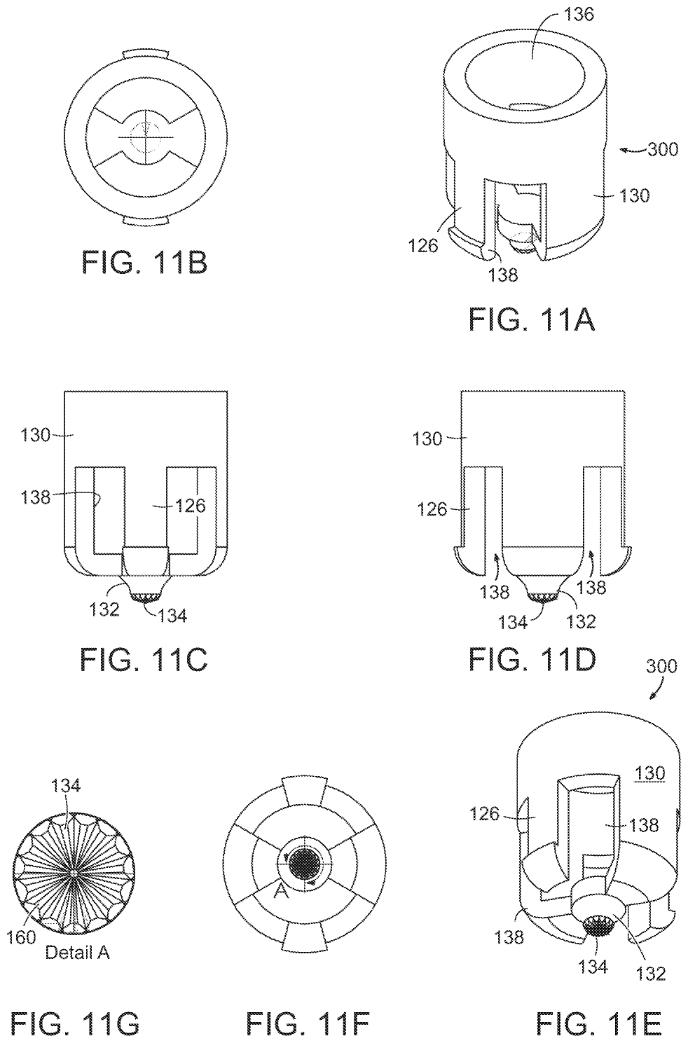

FIGS. 11A-11G illustrates yet another embodiment of a device 300 which is configured to be inserted into a well plate 10. It should be appreciated that these figures are a magnified view of one post 130 portion of the device 300. This figure set includes many components that have been described above and shown in FIGS. 1A-1F and 10A-10G, and thus like components have been given identical reference numbers. Representative measurements (in mm) and details are shown for this particular embodiment. As mentioned above, the posts 130 are sized to be inserted into the wells 12 of a well plate 10, and as shown, there is a post passageway 136 that extends through the post 130. The post 130 has a terminus end 132, and as shown, the terminus end 132 may include a tapered tip 134. As mentioned above, the terminus end 132 of the post 130 may be used to collect one or more solutions used to process a sample.

As discussed in more detail below, the post tip 134 may include one or more features that promote fluid retention on the surface of the tip 134. As shown in FIGS. 11E-11G, in one embodiment, the tapered tip 134 has a plurality of pleats 160. This pleated configuration is designed to retain a solution and to allow a gel solution to expand while the device is present in the well 12.

As shown in FIGS. 11A-11G, the post 130 has one or more openings 138 along the post sidewalls. It should be appreciated that these openings 138 may enable a fluid to travel through the post passageway 136 and out through the openings 138. In this illustrative embodiment, the post sidewalls include at least one prong 126 extending downwardly. In one embodiment, there are a plurality of prongs 126 separated by a plurality of openings 138, and as shown in FIGS. 11C, 11E and 11F, in one embodiment, two opposing prongs 126 connect in the center of the post 130 at the terminus end 132 with the tapered tip 134.

As mentioned above, the present disclosure contemplates a variety of types of tapered tips 134 that are configured to promote fluid retention on the surface of the tips 134 and/or also permit a gel solution to expand when the device is placed in a well plate 10.

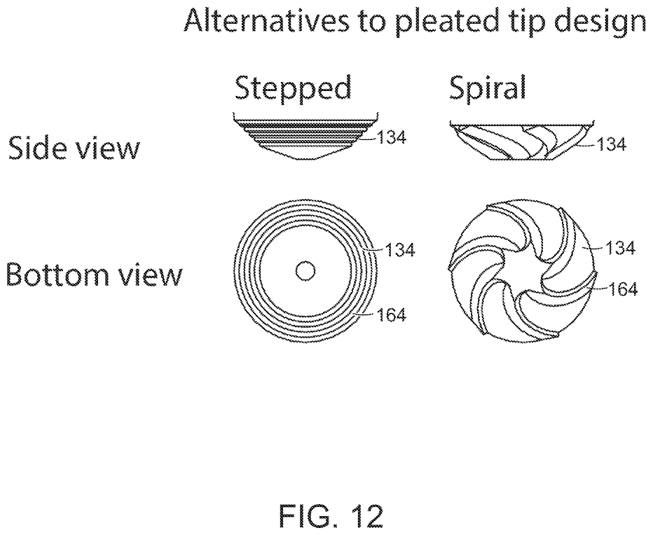

FIG. 12 illustrates detailed side views and bottom views for two additional types of tapered tips 134 that can be alternatives to the above-described tapered tips, such as the pleated configuration shown in FIGS. 11A-11G. In particular, FIG. 12 illustrates both a stepped tapered tip 134 which includes a plurality of steps 162 and a spiral tapered tip 134 which includes a plurality of spirals 164. It should be appreciated that the embodiments shown in FIGS. 11A-11G and 12 all include a tapered tip 134 that includes a feature (such as, but not limited to a pleat 160, a step 162, and/or a spiral 164) that forms open capillary channels on the outer tapered surface. These grooves, raised regions or other patterns which are formed into the tapered tip 134 to form the open capillary channels, provide more surface area for fluid retention and enable the gel solution to expand. As shown in both the pleated tapered tip 134 configuration shown in FIGS. 11A-11F, and also in the spiral design shown in FIG. 12, in some embodiments, the feature (i.e. pleats 160 or spirals 164) which form the open capillary channels is centered on the outer tapered surface and radiates outwardly.

As shown in FIGS. 2 and 9, the present disclosure also contemplates methods of processing a plurality of samples in a well plate. The method may include providing a well plate 10, the well plate having a plurality of wells 12, and depositing a plurality of samples in the plurality of wells. The method may also include providing a first device 100 configured to be inserted into the well plate 10, where the first device 100 includes a plurality of posts 130 sized to be inserted into the plurality of wells 12, and the plurality of posts 130 may have a plurality of post passageways 136 extending therethrough, where the plurality of posts has a terminus end which includes a tapered tip. The method further includes depositing a first solution onto the plurality of tapered tips of the first device 100, and inserting the first device 100 into the well plate 10 such that the plurality of posts 130 is inserted into the plurality of wells 12 of the well plate to mix the first solution with the plurality of samples in the plurality of wells.

In one embodiment, the method of processing a plurality of samples in a well plate further includes removing the first device from the well plate, and providing a second device configured to be inserted into the well plate. The second device may include a plurality of posts sized to be inserted into the plurality of wells, and the plurality of posts may have a plurality of post passageways extending therethrough, where the plurality of posts has a terminus end which includes a tapered tip. The method may further include depositing a second solution onto the plurality of tapered tips of the second device and inserting the second device into the well plate such that the plurality of posts is inserted into the plurality of wells of the well plate to mix the second solution with the plurality of samples in the plurality of wells.

As shown in FIG. 2, the step of depositing a first solution onto the plurality of tapered tips 134 of the first device may include dipping the plurality of tapered tips of the first device into a reservoir containing the first solution. Furthermore, as shown in FIG. 2, the step of depositing a second solution onto the plurality of tapered tips of the second device may include dipping the plurality of tapered tips of the second device into a reservoir containing the second solution. As set forth in more detail below, in one embodiment, the first solution is a gel solution containing tetramethylethylenediamine (TEMED) and the second solution is a gel solution containing ammonium persulfate (APS). In one embodiment, the second solution mixes with the first solution to initiate polymerization of the samples in the plurality of wells. As set forth in greater detail below, in one embodiment the method is used for Expansion Microscopy (ExM).

As discussed above and as shown in FIG. 9, in one embodiment, the first solution includes a gel solution containing a photo-initiator. In one embodiment, the method further includes irradiating the well plate with UV light 10 to initiate polymerization of the cell samples in the wells 12.

### Examples

In one particular embodiment, to convert conventional ExM to a multi-well platform, the Applicant designed a well-plate insert that deposits droplets of gel solution in each well of a 96-well plate. It should be appreciated that any of the above-described devices 100, 200, 300 may be utilized. This device allows for full and reproducible gel expansion within the constrained area of each well of a 96-well cell culture plate. Specifically, hiExM requires the addition of ≤1 μL of gel solution to cultured cells compared to ˜200 μL for standard ExM, corresponding to significantly reduced ˜1.4 mm diameter gel footprint. The device is designed such that the cylindrical posts 130 enable loading of sub-microliter volumes of gel solution to each well (ex. FIG. 1A). The posts 130 retain small volumes (<1 μL) of solution when dipped and removed from a fluid reservoir allowing for delivery of the gel solution using a dip-stamp strategy (i.e., representative methods shown in FIGS. 2 and 9). In one embodiment, the device posts 130 may first be immersed in a gel solution containing tetramethylethylenediamine (TEMED), one of the two initiators of free radical polymerization (i.e., oxidation-reduction chemistry as indicated above). The device delivers a droplet of TEMED gel solution in the base of the well containing fixed cells pre-treated with the AcX cross-linker (Monomer×solution, see Methods). Then, a second identical device may be used to deliver a droplet of gel solution containing ammonium persulfate (APS), the other free radical initiator for gel formation, and this device may be left in place. The two gel solutions mix to initiate polymerization inside the well resulting in the formation of toroidal gels where the inner surface is molded by the device and the outer surface is stabilized by surface tension. The toroidal geometry of the gel combined with the sloped surface of the conical post-tip allow the gel to expand while the device is present in the well 10. Gel expansion causes the gel to delaminate from the post, enabling robust removal of the device without disrupting the gel for downstream imaging.

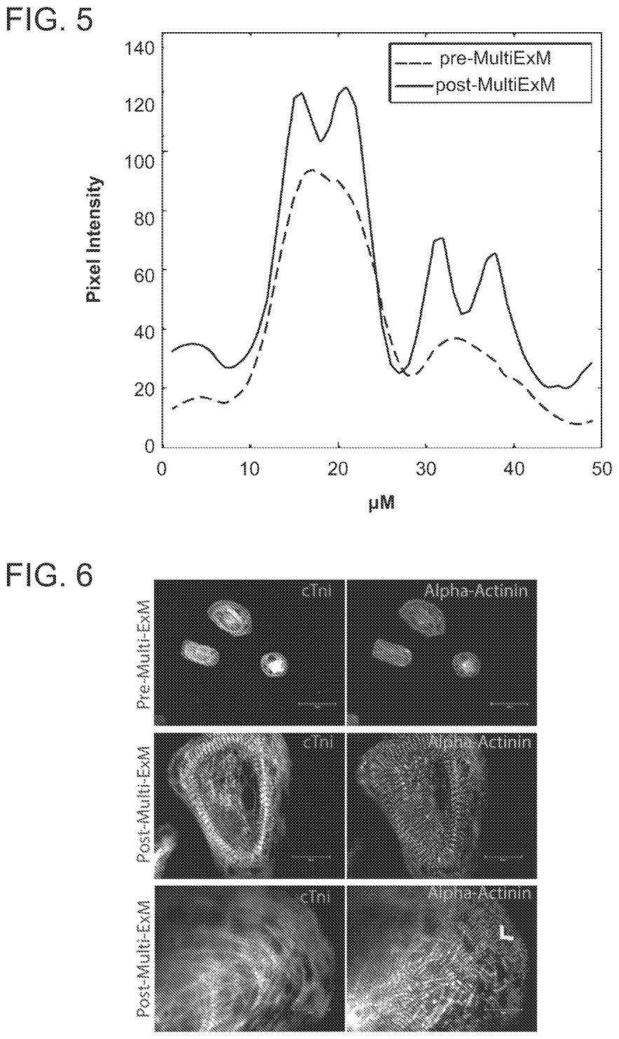

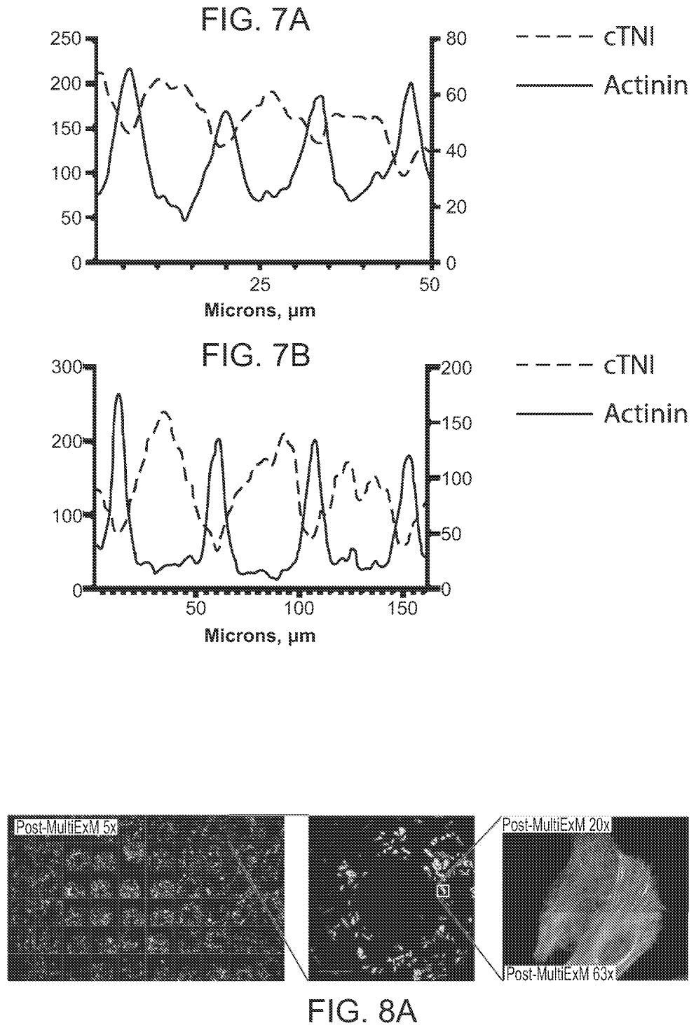

To validate the platform, the Applicant first measured the isotropy of gel expansion as described. hiExM was performed using cultured MEFs treated with anti α-tubulin antibodies in a 96-well plate. Cells were imaged pre- and post-expansion using both fluorescence confocal microscopy (FIG. 3). Images of expanded cells are expected to show a higher effective resolution due to an increase in distance between the fluorescent molecules beyond the Rayleigh limit. To compare the resolution before and after expansion using hiExM, post-expansion images were registered to their respective pre-expansion images by similarity transformation with a rigid body transform in the ImageJ plugin TurboReg. It is shown that hiExM resolves individual microtubules that are closer together as a result of expansion of the sample similar to conventional ExM (as shown in FIG. 5). As an example of how this approach can be applied to human patient specific cells, the Applicant also cultured induced pluripotent stem cell (iPSC) derived cardiomyocytes (iCMs) in 96-well plates and analyzed their sarcomere structures. The sarcomere components α-actinin and cardiac troponin I (cTnI) are resolved using hiExM and sarcomere assembly can also be visualized at the iCM periphery, in contrast to pre-expanded cells (FIGS. 6, 7A, and 7B). Thus, the platform recapitulates the resolution of conventional ExM at a greatly increased scale enabling high-throughput expansion of diverse cell types.

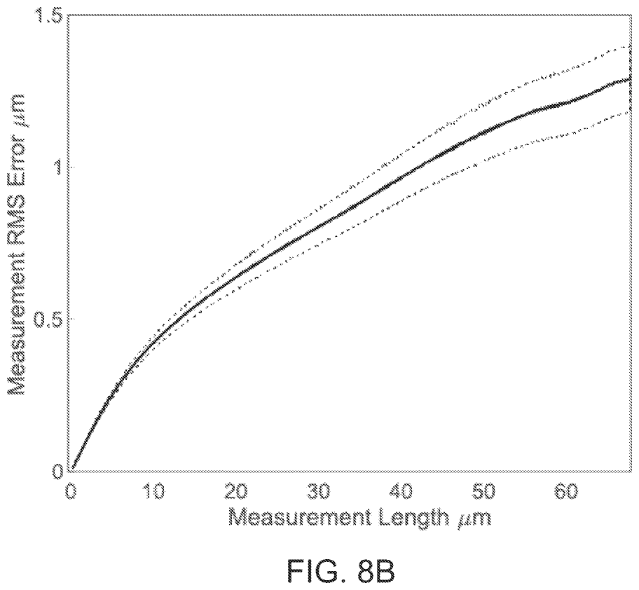

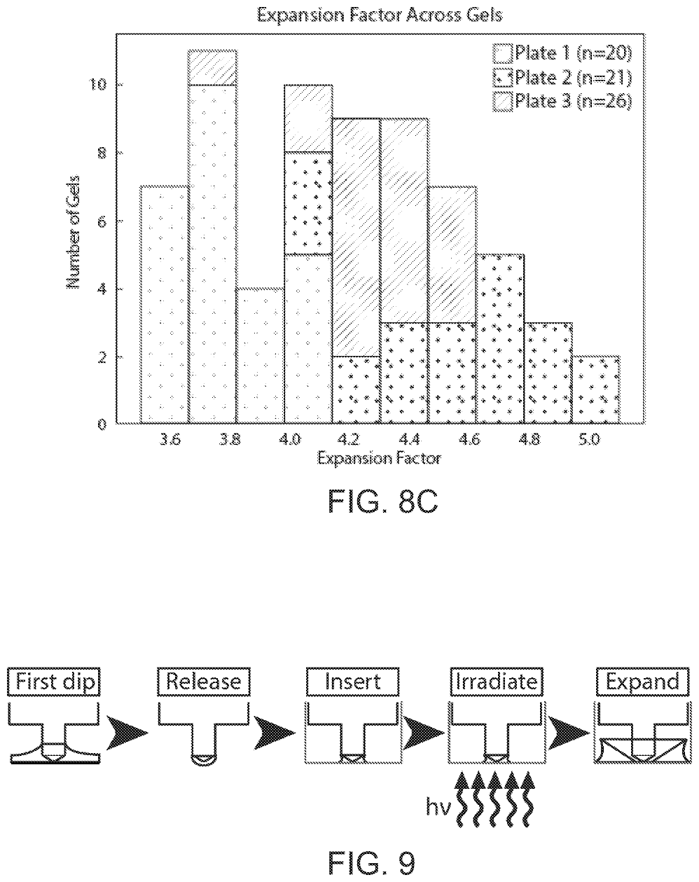

The Applicant recognized that one major bottleneck associated with super resolution imaging or ExM approaches is the time and expertise required to image individual samples. Strategies that allow autonomous three-dimensional (3D) image capture and data acquisition of expanded samples are needed to fully realize the potential of this approach. For example, the vertical component of expansion decreases the signal-to-noise ratio by increasing the depth of the sample; therefore, confocal imaging is necessary to resolve subcellular structures. Additionally, the expansion gel is not bound to the culture surface and can reposition within the well thereby increasing search space for planar coordinates and focal depths needed to properly image an expanded specimen. To image expanded samples in each well based on signal location, the Applicant adapted hiExM expansion of A549 cells to image acquisition on the PerkinElmer Opera Phenix system. The significant increase in data acquisition allows quantification of the isotropy and reproducibility of gel expansion across all wells of the plate. A549s were first immunostained with anti α-tubulin antibodies and imaged pre-expansion by selecting an area in the center of each well around the device post position at 63× using Harmony software (PerkinElmer). Using the same plate, post-expansion imaging was then performed in two stages: (1) each well was imaged at 5× magnification to identify the coarse X, Y, and Z coordinates of cells within the expanded gel and (2) areas or individual cells within the gel were then randomly selected for imaging at higher magnification (FIG. 8A). To restrict gel movement between the first and second stages, it was found that removal of residual water from each well followed by addition of ˜100 μL of mineral oil improved autonomous imaging. This platform enables the user to autonomously collect images of all wells within a plate and can be further scaled to multiple plates.

The Applicant next analyzed image distortion by comparing the same A549 cells pre- and post-expansion using a non-rigid registration process. Due to the device placement, the analysis was focused on the central 60 wells of the plate. Of note, one could easily and rapidly identify the same cell before and after expansion using the Opera Phenix high-content imaging system whereas these comparisons are extremely tedious and time consuming using conventional confocal imaging of individual wells. Distortion from swelling was calculated with the root mean squared error (RMSE) of a 2-dimensional deformation vector field by comparing the same cell before and after expansion. Qualitatively, cells appear similar pre- and post-expansion, and quantitatively the RMSE of a given distance between two points in the same cell was ˜2-3% compared to ˜1% for conventional ExM (FIG. 8B). This slightly higher error is expected given that a proportion of the sample area is subject to edge effects due to the small volume of each well. However, one may not expect an impact on interpretability of biological structures.

To test the reproducibility of this platform, the Applicant next analyzed the expansion factor across wells by measuring the fold-increase in length between two points in each field of view before and after expansion. The reference points for these measurements were arbitrarily chosen in images of A549 cells immunostained with anti α-tubulin antibodies. The mean expansion factors across wells for three independent well plates were 3.78, 4.26, and 4.53 with standard deviations of 0.171, 0.171, and 0.321, respectively. The average expansion factor across all wells was 4.16 with a standard deviation of 0.394 (FIG. 8C). Thus, the hiExM platform recapitulates the 3D structure of pre-expanded cells allowing for simultaneous expansion and imaging of up to 60 samples in a single plate. This process can be further scaled to multiple plates broadening the utility of expansion microscopy for a range of applications.

As outlined, in one embodiment, the above hiExM is a robust and scalable strategy for parallel analysis of a large number of samples. It is contemplated that this platform can be adapted to the analysis of diverse cell types using conventional cell culture methods. In one embodiment, the low manufacturing cost of the device combined with the relative simplicity of the benchtop setup make hiExM readily accessible for use in both academic and pharmaceutical settings. In one embodiment, hiExM is an enabling platform that allows for high-resolution biological discovery, where many conditions and technical replicates are necessary. Moreover, small molecule drug screens as well as evolving drug modalities including the delivery of nucleic acids, antibody drug conjugates, and gene therapy vectors have vastly increased the number of drug candidates necessitating robust and accessible methods to gain spatial information about cellular response in addition to conventional methods of validating safety and efficacy. In one embodiment, hiExM offers a strategy for improved image and spatial resolution of cellular structures in single human cells across thousands of cells and the data output can be combined with machine learning tools for achieving unprecedented insights that will enable both biological and translational discovery in the same platform.

### Materials and Methods

hiExM Device Fabrication

In one embodiment, hiExM devices were fabricated from polysulfone (McMaster-Carr 86735K74) using a Trak DPM2 CNC milling machine. Technical specifications of the device are described above and shown in FIGS. 10A-10G.

hiExM Workflow

### Redox Polymerization of Expansion Gels

Cells fixed with 4% paraformaldehyde (PFA) were stained with traditional immunofluorescence protocols and treated with Monomer solution (6-((Acryloyl) amino) hexanoic acid, abbreviated AcX) (Life Technologies) for at least 3 hours at room temperature prior to gelation as per published ExM protocols. Cells were then washed twice with PBS and aspirated to remove excess liquid. At this point, the aspirated well plate, two 2 mL vials of Stock X, TEMED and APS (40 g/100 mL), and an aluminum block were put on ice and placed in a glove bag. The glove bag was then purged and backfilled with dry nitrogen twice. 40 uL of APS or TEMED were added to 2 mL of Stock X followed by light mixing. Both Stock X solutions (one containing APS and the other containing TEMED) were then poured onto separate absorbent pads. One device was then dipped into the TEMED-containing solution, stamped into a set of wells, and the process was repeated with the same device to load droplets of TEMED harboring Stock X in all wells. Five separate devices were then dipped in the APS-containing solution, then immediately inserted into the well plate. The plate was left on ice for 15 minutes, then inverted and placed on the working surface within the glove bag. ˜2 mL of water was applied to the underside of the well plate (for thermal conduction) and a bladder of ˜50° C. water was laid over top of the inverted well plate to warm the gels for 5 min. The well plate was removed and 100 μL of digestion solution was added to each gel-containing well, at which point the well plate was left overnight at room temperature. The following day, the well plate with devices was submerged in ˜2 liters of deionized (DI) water under constant agitation for 2 hours twice, refreshing the water after the first two hours. Finally, the plate was removed from the water bath and devices removed from the well plate.

### Photopolymerization of Expansion Gels

Cells fixed with 4% paraformaldehyde (PFA) were stained with traditional immunofluorescence protocols and treated with Monomer solution (6-((Acryloyl) amino) hexanoic acid, abbreviated AcX) (Life Technologies) for at least 3 hours at room temperature prior to gelation as per published ExM protocols. Cells were then washed twice with PBS and aspirated to remove excess liquid. At this point, the well plate and a darkened conical tube containing 1 mL of 0.1% Irgacure2959 in gel solution were brought into a glove bag. The glove bag was then purged and backfilled with dry nitrogen twice. At this point, the gel solution was poured out onto an absorbent pad. Five separate devices were then dipped into the gel solution and immediately inserted into the well plate. The plate was then irradiated with 365 nm light (˜50 mW/cm\hat{ }2) for 60 seconds. At least 100 μL of digestion solution was added to each gel-containing well, at which point the well plate was left for ˜6-7 hours. After, the well plate was submerged in ˜2 liters of DI water overnight under constant agitation. Finally, the plate was removed from the water bath and devices removed from the well plate.

### Cell Culture

Human A549 cells and mouse embryonic fibroblasts (MEFs) were maintained in culture at a density between 2×10³ and 1×10⁴ cells/cm² in DMEM modified with 10% fetal bovine serum and 1% penicillin-streptomycin. Cells were passaged once every 4-7 days for maintenance based on confluency. Glass and plastic 96-well plates were seeded at between 1×10⁴ and 7×10⁴ cells/cm² for experiments and were fixed at the desired level of confluency. For experiments with MEFs, well plates were coated with poly-L-lysine prior to cell seeding. Induced pluripotent stem cell-derived cardiomyocytes were purchased from cellular dynamics (CMC-100-012-011) and cultured as previously described (Fenix et al. 2018).

### Immunofluorescence

Cells were immunostained according to Active Motif MaxPack™ Immunostaining Media Kit's protocol and reagents. Briefly, cells were fixed with 4% PFA for 15 minutes and then blocked with MAXblock blocking medium (Active Motif) for 1 hr. Cells were then incubated overnight at 4° C. with primary antibodies in MAXstain (Active Motif) followed by addition of secondary antibodies in PBS for 1 hr at room temperature and counter-stained with Hoechst (Fisher Scientific) to visualize individual nuclei. Cells were washed between every stage in MAXwash (Active Motif) 3 times for 15 mins.

| | | Cat. |
|---|---|---|
| | Vendor | Number |
| Primary Antibodies | | |
| Anti-Lamin A/C antibody | Santa Cruz | sc-376248 |
| Monoclonal Anti-alpha-Tubulin antibody | MilliporeSigma | T5168 |
| Anti Alpha-Actinin antibody | MilliporeSigma | A7811-2mL |
| Anti Cardiac Troponin I antibody | Abcam | ab56357 |
| Secondary Antibodies | | |
| CF633 Chicken Anti-Mouse IgG (H + L) | Biotium | 20222-1 |
| Alexa Fluor 488 goat anti-mouse IgG (H + | Invitrogen | A11029 |
| L) | | |
| Alexa Fluor 546 donkey anti-goat IgG | Invitrogen | A11056 |
| (H + L) | | |

### Microscopy

Confocal imaging was performed on pre- and post-hiExM samples on multiple microscopes for comparison. Prior to adaptation to the Opera Phenix (PerkinElmer), cells were imaged using a Nikon A1R with a 40×1.15 NA water immersion objective. Pre-expansion imaging on the Opera Phenix system (PerkinElmer) was performed using a 63×1.15 NA water objective. Post-expansion imaging on the Opera Phenix was first performed at 5× to establish the location of cells of interest in X, Y and Z in each gel. A subset of cells was then autonomously chosen to image at a higher magnification using either a 20×1.0 NA water objective or 63×1.15NA water objective.

### Image Analysis

### Non-Rigid Registration

Non-rigid registration analysis was performed to ensure isotropic swelling of cells across a single gel. Cells were chosen at increments from the center of the gel post expansion and compared to the same cell pre-expansion. Non-rigid registration was performed with a custom MATLAB package. Briefly, pre- and post-expansion images are histogram normalized and masks are generated to exclude regions with no features by applying a Gaussian blur. B-spline-based registration package in MATLAB was used to perform non-rigid registration between the images. B-spline grids increased in density from 64 pixels per grid point to 8 pixels per grid point.

The present disclosure also contemplates ways to automate one or more of the above-described steps. In one embodiment, an automated machine is provided which is configured to manipulate at least two of the above described devices 100 to fulfill the steps disclosed in FIG. 2. In particular, in one embodiment, an automated machine is configured such that each device 100 can be sequentially dipped into a monomer solution, removed from the monomer solution by lifting vertically, and then placed into the well plate 10. As discussed above, the first device 100 may be removed from the well plate 10, and the second device 100 may remain in the well plate 10 for the duration of the experiment. In one embodiment, the automated machine is configured so that the devices 100 can be mounted onto the machine and each of the posts 130 may be exposed from above. In one embodiment, the posts 130 may be exposed from above so that, after the gels are polymerized, digestion buffer (and later, water) can be loaded into the wells from above (through the post passageways 136). In one embodiment, the automated machine is configured to be air-tight. Also, in one embodiment of the automated machine, the solution reservoirs are removable modules.

In one embodiment, the automated machine has an inlet for dry nitrogen and an outlet for a vacuum. The automated machine may also include a door with a gasket that allows a user to place the well plate 10 in the machine and seal the machine for the process. The machine may also include a pressure relief valve to release gas from inside the machine in the event that it becomes over-pressurized.

In one embodiment, the above described first and second solutions are both monomer solutions that must be kept cold. In one embodiment, the automated machine includes a Peltier junction, which is a flat device that gets hot on one side and cold on the other side when a voltage is applied to it. These may be affixed to the underside of the monomer reservoir with a thermal paste glue, and a fan may be employed to blow air through the heat sink to circular the cool air to maintain a temperature, such as 4° C. in the monomer reservoir. In one embodiment, the monomer reservoirs are thermally insulated.

In one embodiment, the automated machine is also configured so that the well plate 10 can be temperature controlled. In one embodiment, the automated machine is configured so that the well plate 10 starts off at cold temperature and then may be heated for a short period of time, such as for 5 minutes.

Once the second device 100 is placed into the well plate 10, the gel droplets in the well plate are able to polymerize because the two molecules that react with one another to initiate polymerization (TEMED, which is present in the first solution 1; and APS, which is present in the second solution) start mixing when the second device 100 is placed in the well plate. It may be desirable to keep the actively polymerizing droplet cold for about 15 min to slow down the polymerization reaction, allowing the TEMED and APS to perfuse into the cells. After about 10 min, the droplets then may be heated to ˜50° C. for about 5 min to allow the polymerization reaction to complete.

In one embodiment, it may be desirable for the automated machine to rapidly change temperature from cold to hot. One approach is to use a heating device that can change rapidly from cold to hot (ex. Peltier junctions can do so by changing the direction of the current). It may be desirable to minimize the mass (and also the specific heat capacity) of the object that interfaces between the Peltier junction and the well plate. Minimizing the specific heat capacity will minimize the amount of energy needed to change the temperature of the object, minimizing the time it takes to change that temperature. It is also contemplated that a second approach for the automated machine to rapidly change temperature is by mechanically changing the substrate underneath the well plate 10 from a cold substrate to a hot substrate. In one embodiment of the automated machine, there is autonomous monomer solution loading. In one prototype, the monomer solutions may be loaded manually into the machine. However, in another embodiment, the automated machine may include wet plumbing and pumps that autonomously load the monomer reservoirs.

Furthermore, in one embodiment of the automated machine, there may be autonomous digestion buffer and deionized (DI) water loading. In one prototype, the last two steps of the protocol, digestion and expansion, may be carried out manually outside of the machine. In another embodiment, the automated machine may include an array of 24 large-bore needles plumbed to deliver digestion buffer AND deionized water. This setup may necessitate valves that allow for digestion buffer to be added first, then deionized water after the digestion is complete. The array of needles may need to move vertically so as to bring the needles close to and above the device/well plate after the gels polymerize. In another embodiment, this vertical translation may not be necessary as the solutions could simply be dripped from above the well plate into the device.

### EQUIVALENTS

It is to be understood that the methods and compositions that have been described above are merely illustrative applications of the principles of the invention. Numerous modifications may be made by those skilled in the art without departing from the scope of the invention.

Although the invention has been described in detail for the purpose of illustration, it is understood that such detail is solely for that purpose and variations can be made by those skilled in the art without departing from the spirit and scope of the invention which is defined by the following claims.

The contents of all literature references, publications, patents, and published patent applications cited throughout this application are incorporated herein by reference in their entirety.

What is claimed is:

1. A device configured to be inserted into a well plate, the device comprising:
a main body having a top side and a bottom side;
a plurality of posts extending downwardly from the bottom side of the main body, wherein the plurality of posts is sized to be inserted into a well plate;
a plurality of post passageways extending through the plurality of posts; wherein the plurality of posts each have a terminus end opposite the main body, wherein the terminus ends of the plurality of posts include a plurality of tapered tips; and
wherein the plurality of tapered tips includes an outer tapered surface, and wherein there is at least one feature that forms open capillary channels on the outer tapered surface.

2. The device of claim 1, wherein the plurality of tapered tips includes a plurality of conical shaped tips.

3. (canceled)

4. The device of claim 1, wherein the at least one feature that forms open capillary channels on the outer tapered surface includes a feature that is centered on the outer tapered surface and radiates outwardly.

5. The device of claim 2, wherein the plurality of tapered tips includes a plurality of truncated conical shaped tips.

6. The device of claim 1, wherein the plurality of posts includes a sidewall having at least one cutout.

7. The device of claim 6, wherein the plurality of posts includes at least one prong extending downwardly.

8. The device of claim 1, further comprising:
a plurality of pressure struts extending downwardly from the bottom side of the main body, wherein the plurality of pressure struts is sized to be inserted into a well plate.

9. The device of claim 8, wherein the main body has a right side and a left side, the plurality of pressure struts including at least a first pressure strut positioned on the left side of the main body, and a second pressure strut positioned on the right side of the main body.

10. The device of claim 9, wherein the first pressure strut includes a plurality of prongs.

11. A device configured to be inserted into a well plate, the device comprising:
a main body having a top side and a bottom side;
a plurality of posts extending downwardly from the bottom side of the main body, wherein the plurality of posts is sized to be inserted into a well plate;
a plurality of post passageways extending through the plurality of posts;
wherein the plurality of posts each have a terminus end opposite the main body, wherein the terminus ends of the plurality of posts include a plurality of tapered tips; and
wherein the main body has a right side, a left side, and a center positioned between the right side and the left side, each of the plurality of posts having a length, wherein the length of a post positioned in the center of the main body is longer than the length of a post positioned on the right side of the main body.

12. The device of claim 11, wherein the length of a post positioned in the center of the main body is longer than the length of a post positioned on the left side of the main body.

13. The device of claim 1, further comprising a plurality of notches on the bottom side of the main body, wherein the plurality of notches permit flexing of the main body as the device is inserted into a well plate.

14. The device of claim 1, wherein the plurality of posts includes an array of at least 12 posts extending downwardly from the bottom side of the main body.

15.-16. (canceled)

17. A method of conducting expansion microscopy in a well plate, the method comprising:
providing a well plate, the well plate having a plurality of wells;
depositing a plurality of samples in the plurality of wells;
providing a first device configured to be inserted into the well plate, wherein the first device includes:
a plurality of posts sized to be inserted into the plurality of wells; wherein the plurality of posts has a plurality of post passageways extending therethrough, and wherein the plurality of posts each have a terminus end, wherein the terminus ends of the plurality of posts include a plurality of tapered tips;
depositing a first solution onto the plurality of tapered tips of the first device;
inserting the first device into the well plate such that the plurality of posts is inserted into the plurality of wells of the well plate to mix the first solution with the plurality of samples in the plurality of wells and polymerize into a gel; and
expanding the gel to form a substantially toroidal shaped gel within at least one of the wells, while the plurality of tapered tips of the first device remains inserted into the plurality of wells of the well plate.

18. The method of claim 17, wherein the first solution includes a gel solution containing a photoinitiator.

19. The method of claim 18, further comprising:
irradiating the well plate to initiate polymerization of the samples in the plurality of wells.

20. (canceled)

21. The method recited in claim 17, further comprising before the expanding of the gel:
removing the first device from the well plate;
providing a second device configured to be inserted into the well plate, wherein the second device includes:
a plurality of posts sized to be inserted into the plurality of wells; wherein the plurality of posts has a plurality of post passageways extending therethrough, and wherein the plurality of posts each have a terminus end, wherein the terminus ends of the plurality of posts include a plurality of tapered tips;
depositing a second solution onto the plurality of tapered tips of the second device; and
inserting the second device into the well plate such that the plurality of posts is inserted into the plurality of wells of the well plate to mix the second solution with the plurality of samples in the plurality of wells.

22.-23. (canceled)

24. The method recited in claim 17, wherein the step of depositing a first solution onto the plurality of tapered tips of the first device includes dipping the plurality of tapered tips of the first device into a reservoir containing the first solution, and wherein the volume of the first solution on at least one tapered tip is less than 1 microliter.

25.-27. (canceled)

28. The method of claim 17, wherein the substantially toroidal shaped gel has an inner surface molded by the shape of at least one of the plurality of tapered tips, and as the first solution expands, the substantially toroidal shaped gel delaminates from at least one of the plurality of posts; and
removing the first device from the well plate without disrupting the substantially toroidal shaped gel.

29. The method of claim 17, wherein the plurality of tapered tips includes an outer tapered surface, and wherein there is at least one feature that forms open capillary channels on the outer tapered surface, such that as the first solution expands to form a substantially toroidal shaped gel within at least one of the wells, the first solution expands along the capillary channels.
